(19) United States
(12) Patent Application Publication
(10) Pub. No.: US 2002/0098963 A1
(43) Pub. Date: Jul. 25, 2002

(54) Apparatus and method for assembling a cushion into an air bag module

(75) Inventor: Brian C. Ford, Mt. Clemens, MI (US)

Correspondence Address: Breed Technologies, Inc., 7000 Nineteen Mile Road, Sterling Heights, MI, 48314, US

(73) Assignee: Breed Automotive Technology, Inc.

(21) Appl. No.: 09/766,790

(22) Filed: Jan. 22, 2001

(51) Int. Cl. B31B 1/52

(52) U.S. Cl. 493/457

(57) ABSTRACT

The subject invention is an apparatus and method for installing a cushion into a cover to provide for a uniform and consistent thickness of cushion between an inflator/horn assembly and the cover such that variation in the amount of force applied to the cover is minimized. The apparatus for installing the cushion to the cover includes a base for supporting the cover, a housing defining a cavity and having an upper and a lower platform, an air bag housing and a mock inflator attached to a piston. The method includes the steps of attaching the cushion assembly to a mock inflator, securing the cover, compacting the cushion into the cover and around the mock inflator, such that the cushion fills the cavity of the cover; then removing the mock inflator from the cushion to form a cavity within the cushion for the inflator/horn assembly.

### BACKGROUND OF THE INVENTION

This application discloses an apparatus and method of automatically folding a cushion (air bag) and installing an inflator/assembly within an air bag module.

The major components of an air bag module include a cushion and a cover containing the horn assembly. A horn assembly comprising membrane switches is mounted to the cover and is actuated by pressing the exterior of the cover. Such a configuration requires that the cushion be folded in a specific uniform manner. This process however does not produce consistent results. As appreciated, the cushion applies a specific amount of resistance force on the horn assembly. If the cushion is not installed in a consistent uniform manner, the force that needs to be applied to activate the horn will be different from assembly to assembly. Some assemblies may require an excessive amount of force to operate the horn, while others may be activated in a spurious manner simply by the force exerted by the cushion on the horn assembly, which varies over time. For example, after the cushion is installed, there is a settling period wherein the air bag attempts to unfold into a more natural uncompressed state. Such settling may change the amount of force required to activate the horn. In the worst cases the horn may sound without any applied force on the cover. As appreciated, such circumstances create a great deal of customer dissatisfaction.

One configuration that corrects the above problem is to relocate the horn assembly from being between the cover and the cushion to being between the cushion and the inflator. Such a configuration provides for a consistent amount of force applied between the inflator and the horn assembly. However, the problem of consistent cushion folding or compression and the tendency to uncompress still creates unwanted and undesirable variations in the required force that must be applied to the cover to activate the horn mechanism.

For these reasons, an apparatus and method for installing an air bag into a cover that can produce a consistent cushion fold in the area where the horn is located is needed.

### SUMMARY OF THE INVENTION

The subject invention is an apparatus and method for installing a cushion (also referred to as an air bag) into a cover so that a uniform and consistent thickness of the cushion will lie between an inflator/horn assembly and an under surface of the top of the cover. In this manner, variations in the level of force applied to the under surface of the cover, and to the inflator/horn assembly, are minimized.

The invention includes a folding apparatus, machine or assembly for installing the cushion to the cover. The assembly includes a base for supporting the cover, a housing or tube defining an internal cavity and an upper and a lower platform. In one embodiment, an air bag housing and a mock inflator are attached to a piston slidably disposed within the assembly's cavity and movable between the upper platform and the lower platform.

The method of the invention includes the steps of attaching the air bag housing, cushion, and a retaining ring to the mock inflator (in another embodiment just to the piston), placing the cover in the folding assembly, compacting the cushion into the cover and around the mock inflator (if used), such that the cushion fills the interior of the cover, and removing the mock inflator from the cushion thereby forming a cavity or depression within the folded cushion. The actual inflator or inflator/horn assembly is then placed within the depression and secured to the air bag housing. Other folding methods are also disclosed.

The subject method provides for the consistent and automatic installation of the cushion into a cover to yield a consistent cushion fold in particular at or near the top of the inflator/horn assembly. It should be appreciated that the folding method therein can be used independent of the type of horn switch, nor does the method require that a horn switch be placed within the cover. With this invention a consistent predetermined amount of cushion fabric is disposed between the underside of the cover and region of the inflator/horn assembly so that a predetermined level of force applied to the cover will activate the horn (if used).

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is an exploded view of the folding mechanism;

FIG. 2 is a perspective view of the cushion mounted to the air bag housing;

FIG. 2a shows the cushion and air bag housing attached to a spacer or mock inflator FIG. 3 is a perspective view of the folding mechanism in the load position with the cushion in a free state;

FIG. 4 is a view of the folding mechanism in the closed compacting position that shows the cushion prior to installation into the cover;

FIG. 5 is a view of the folding mechanism in the compacting position;

FIG. 6 is a partial cross-sectional view of the folding mechanism in the compacting position;

FIG. 7 is a cross-sectional view of the cover with the cushion installed; and

FIG. 8 is a cross-sectional view of the cover with the cushion and the inflator/horn assembly.

FIG. 9 shows an alternative embodiment of the invention.

FIG. 10 shows an alternate piston.

FIG. 11 is an alternate embodiment of the invention.

FIG. 12 shows an inflator installed in the embodiment of FIG. 11.

### DETAILED DESCRIPTION OF THE PREFERRED EMBODIMENT

Referring to the FIGUREs, wherein like numerals indicate like or corresponding parts throughout the several views, the subject invention is an apparatus and method for installing a cushion 12 into a cover 14. Upon installation of the inflator the module is virtually complete except for permanently fixing the cover and air bag housing together (if needed). The method of folding the cushion and folding apparatus can be used with many different air bag module configurations. In the preferred embodiment of the invention it is contemplated the inflator will be part of an inflator/horn assembly 36. This construction places a pressure horn mechanism or switch upon the top, typically flat surface of the inflator. Those familiar with the construction of air bag modules, and as mentioned above, know that many modules fasten a membrane horn switch to the undersurface of the cover with the air bag resting on the membrane switch while other modules do not contain a horn switch within the module. Other modules float relative to an external horn switch. The folding apparatus and method can be used with these other types of modules as well.

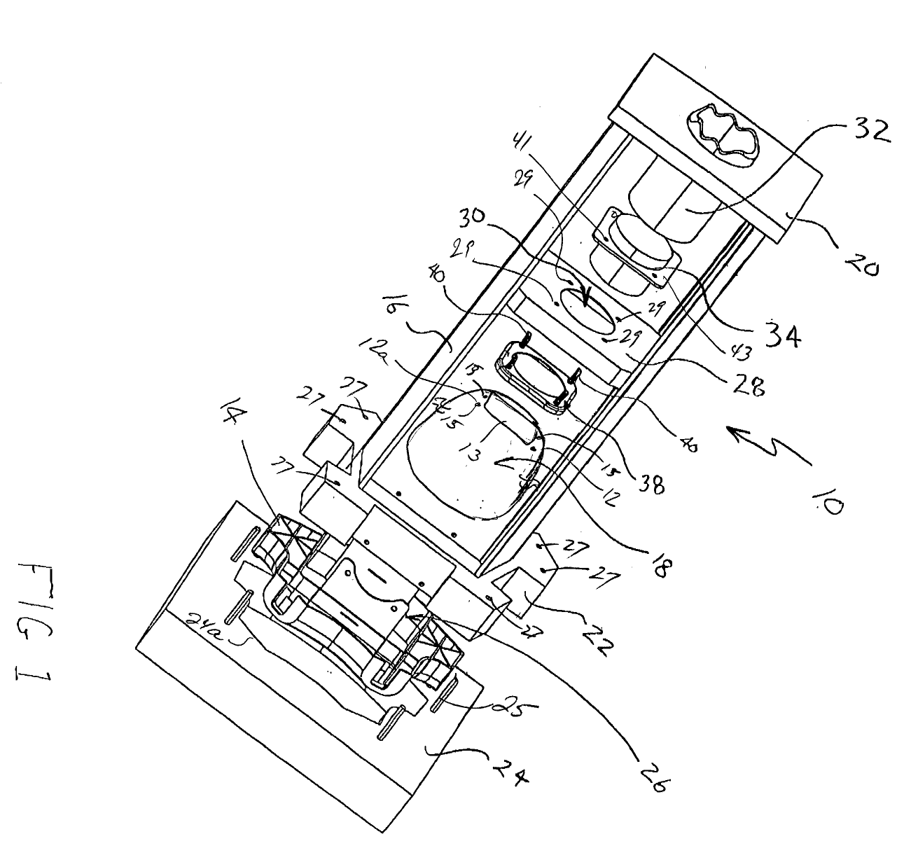

Referring to FIG. 1, the folding apparatus 10 includes a tubular housing or tube 16 having an internal cavity 18. The apparatus also includes an upper and lower platform 20, 22 disposed on opposite ends of the tube 16. It is preferable that at least the front side of the tube 16 is transparent. In practice the tube can be made from extruded clear plastic (one such plastic is Lexan), so all of the walls or sides of the tube are transparent. A base 24 disposed below the lower platform 22 receives and secures the cover 14 and matingly engages with the lower platform 22 of the tube 16. The base includes a cavity 24a having a shape that conforms to the exterior shape of the air bag cover 14. As can be appreciated, the cover is shown elevated relative to the cavity 24a. The tube 16 is movable between a loading position where the lower platform 22 of the housing is pulled or otherwise moved away from the base 24 and an installing position where the lower platform 22 is engaged with the base 24. This can be accomplished in many ways. For example, the base 24 can include a plurality of locating pins 25 that are received within mating apertures in the lower platform 22. The tube can be supported by rails exterior to the tube. As a further alternate, the tube and all of the structure associated with it can be physically lifted from the base to provide access to the base. Alternatively, the pins 15 can be relatively long and the tube can be slid upwardly on these pins while still remaining attached to the pins, again to provide access to the base to permit the cover to be placed upon the base.

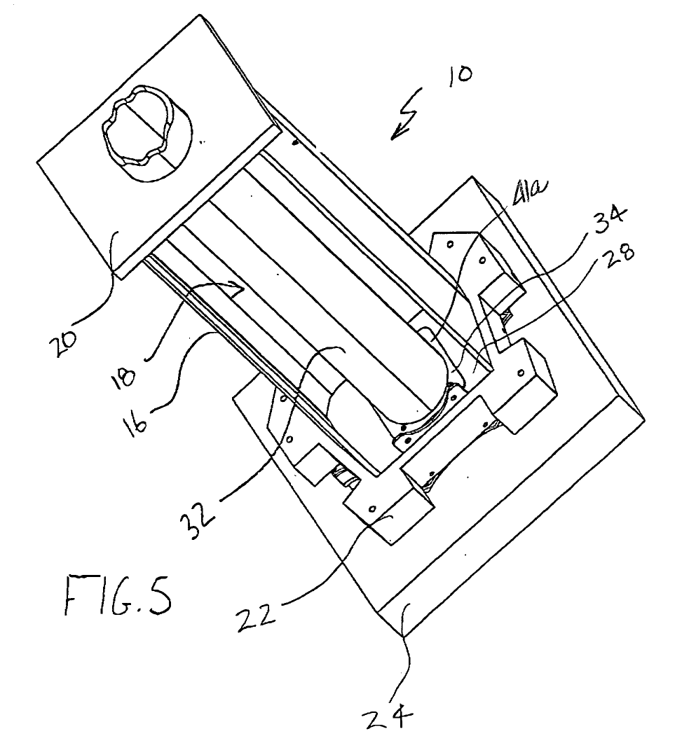

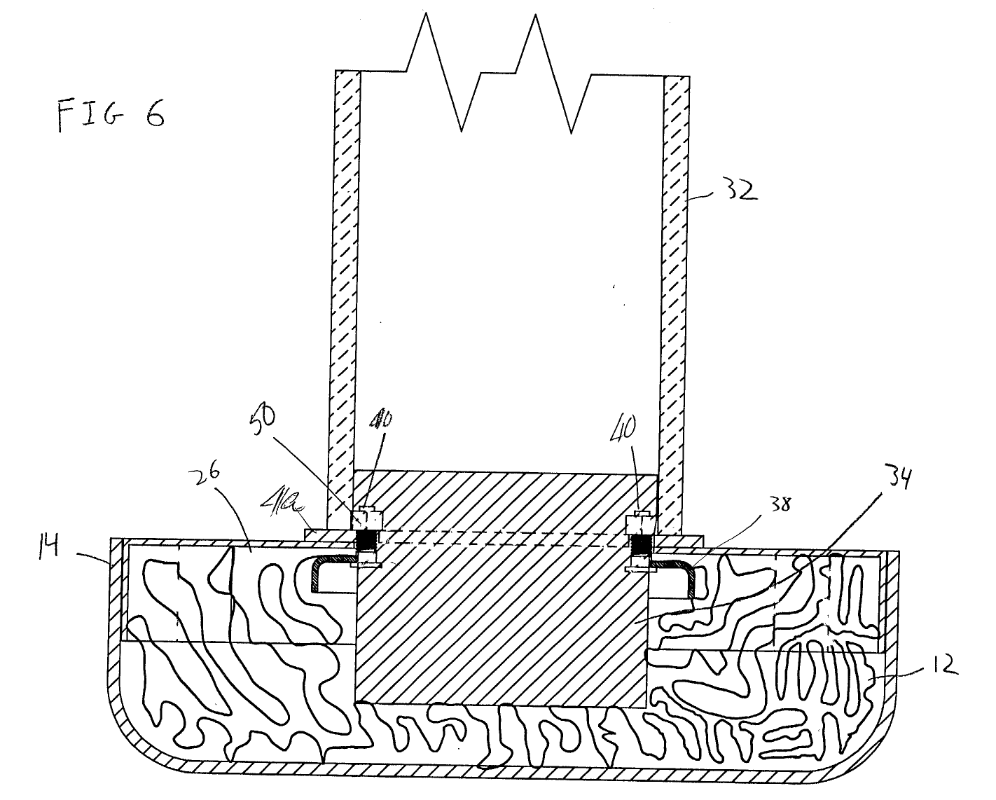

The internal cavity or inside 18 of the tube 16 is shaped to mate or conform with the perimeter of the housing 28 and guides the cushion 12 into the interior, cup-shaped cavity 26 of the cover 14 as the housing is lowered. The air bag housing 28 is slidable within the interior 18 of the tube 16 and is movable between the upper and lower platforms 20, 22. The air bag housing also includes a central opening 30. As shown in the illustrated embodiment, the air bag housing is generally square-shaped but other exterior profiles can be used. As also shown in FIG. 1, the cushion 12 includes an opening 13 in a neck portion 12a thereof. The neck portion also includes a plurality of small openings 15. The folding apparatus 10 further includes a piston 32 that is movable through the upper platform and through the interior or interior cavity of the tube. Preferably, the piston 32 is actuated pneumatically but the piston can be manually moved or activated by mechanical, electrical or other means. This is also true for the tube. A mock or substitute inflator 34, also shown in FIGS. 1 and 6, is attached to the lower end of the piston 32 and is sized to fit into the opening 30 of the air bag housing 28.

It is preferable that the mock inflator 34 is of the same outer shape as the inflator or of the inflator/horn assembly 36 that will be used in the air bag module. As will become apparent from the discussion below, during the folding process, the mock inflator 34 forms a consistent and uniform depression for the later installation of the inflator or inflator/horn assembly 36.

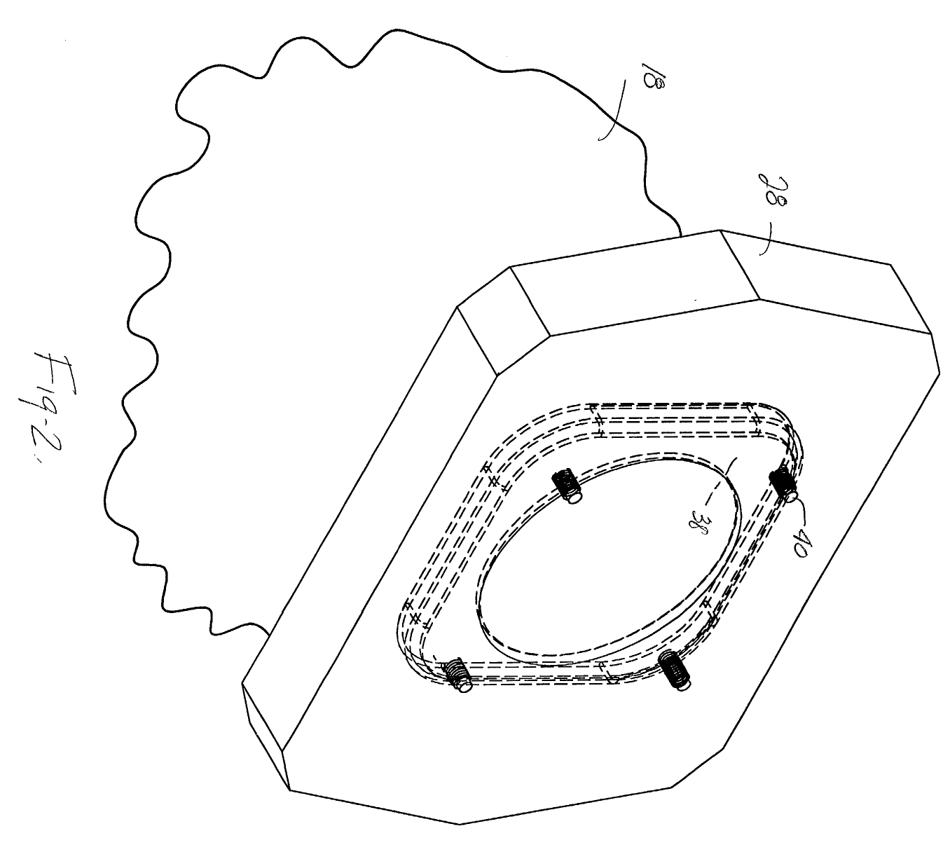

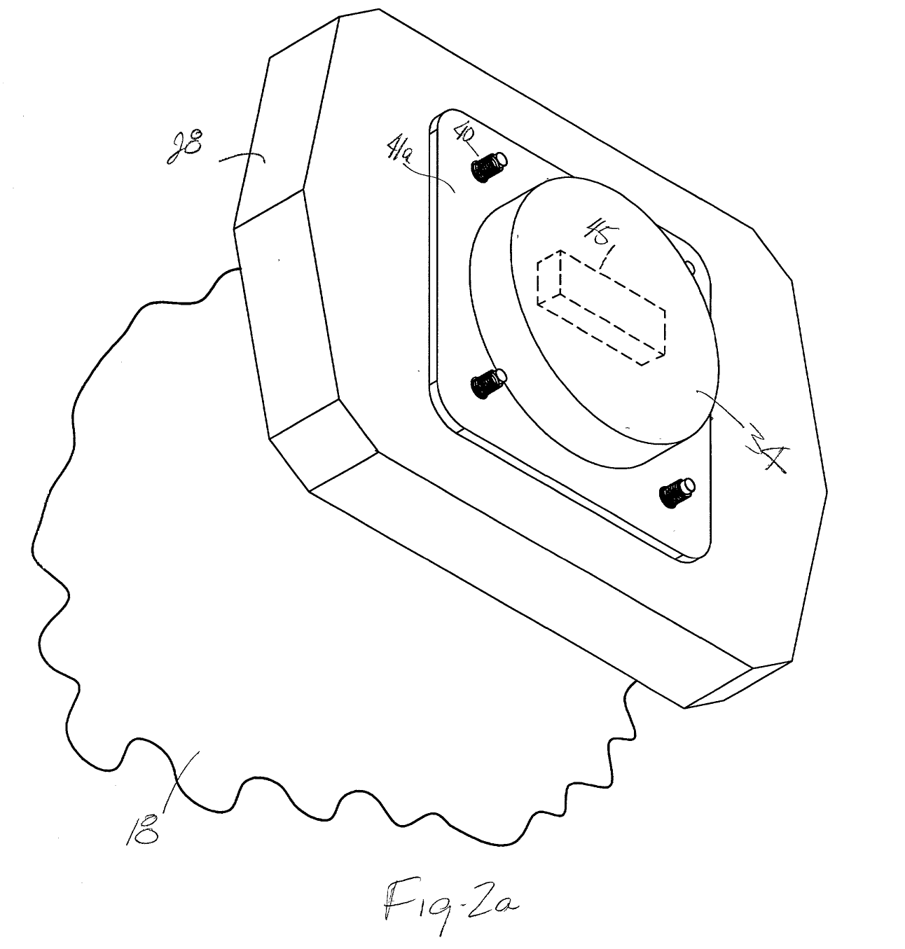

The method of installing or folding the cushion 12 into the cover 14 is as follows. Prior to operating the folding apparatus, a subassembly 31 comprising the air bag housing, retaining ring and cushion is created. The retaining ring is placed within the neck of the cushion with its studs 40 extending through the openings 15 of the cushion. Thereafter the studs 40 are placed through the complementary openings 29 in the air bag housing 28. In this configuration, shown in FIG. 2, the cushion 12 hangs freely from the air bag housing 28.

The subassembly 31 is installed in the folding apparatus by raising or lifting the lower platform 22 (tube 10, etc.) off the base 24 to a height that is convenient for the operator to install the subassembly 31 and also to install the cover into the base. With the tube in an elevated position, the piston 32 is lowered exposing the spacer or mock inflator 34. The subassembly including the housing, retainer and cushion is positioned within the folding apparatus by inserting the retainer studs 40 into the corresponding openings 41 in the flange 43 of the mock inflator 34. This configuration is shown in FIG. 2. As can be appreciated, in the mounted configuration of FIG. 2a, the air bag housing will become aligned with the interior of tube 16 as the flange 41a of the mock inflator, which is attached to the piston (not shown) is aligned to the interior wall of the tube. The subassembly 31 is movable with the piston and mock inflator. Consequently, a means is provided to temporarily connect the subassembly to the mock assembly or piston. The mock inflator or piston can include a permanent magnet, which attracts the metal studs or typically the metal retaining ring or the metal housing. Instead of a magnet, an electromagnet can be installed with the mock assembly or piston. The magnet or electromagnet is diagrammatically shown by numeral 45. A mechanical fastener, such as a nut, can also be used to secure each threaded fastener 40 to the flange of the mock inflator. A number of other mechanical fasteners can be employed.

Referring to FIG. 3, installation continues by placing the cover 14 into the cavity 24a of the base 24. As can be appreciated, the cover can be placed within the base prior to attaching the subassembly to the mock inflator.

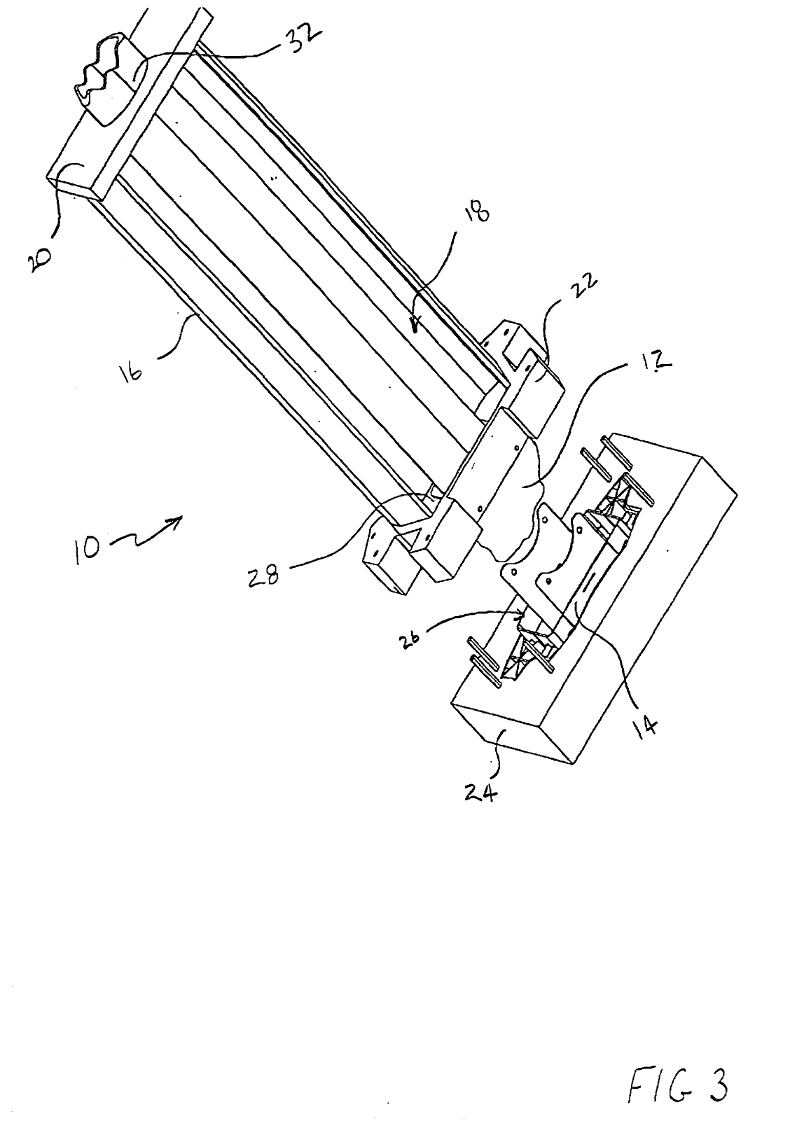

Referring to FIG. 4, installation continues by raising the piston 32 within the tube 16 toward the upper platform 20 to prevent any portion of the cushion 12 from becoming trapped between the lower platform 22 and the base 24. As the piston is raised, the friction between the tube 16 and the cushion will align the cushion to the sides of the tube.

The tube 16 is then lowered to a closed position to engage the base 24. The lower platform 22 closes against the base 24 and around the cover 14. In this position the tube 16 abuts the base 24 and the piston 32 is fully or partially retracted such that the cushion 12 hangs free from the air bag housing 28 within the cavity 18. The interior of the tube 18 guides the cushion 12 into the interior (cavity) 26 of the cover 14 as the piston 32 is lowered. As can be appreciated, the shape of the tube will determine the final outside shape of the cushion, meaning the folded cushion can be made to fit any geometry of the cover, or to a shape that is completely independent of the shape of the cavity 26 of the cover 14.

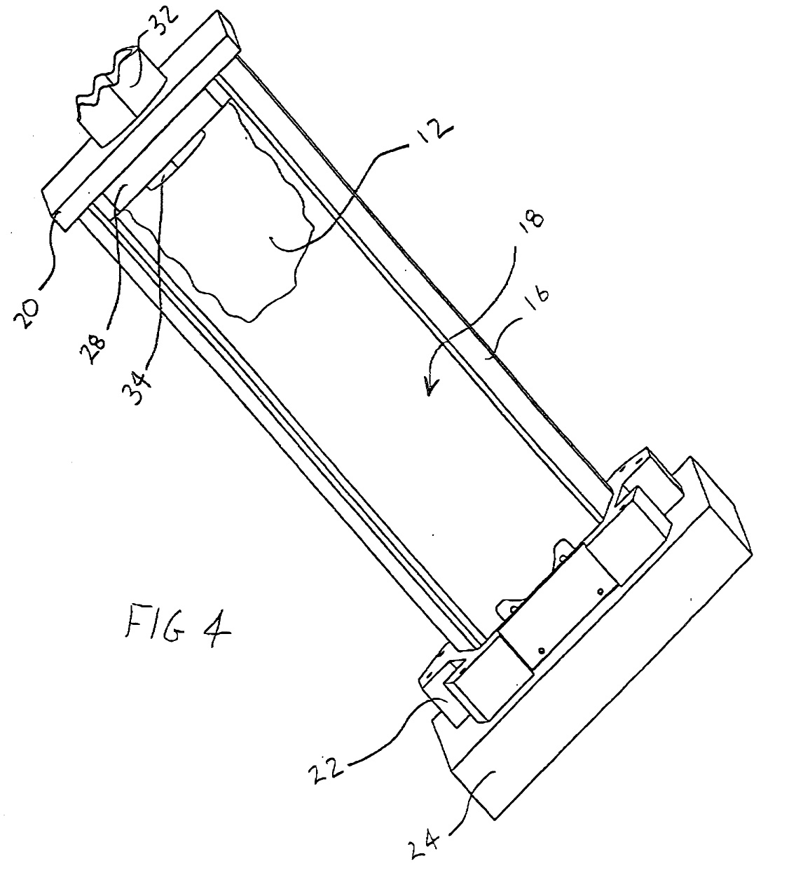

The piston 32 is now lowered pushing the cushion 12 into the cavity 26 or interior of the upturned cover. FIG. 5 shows the piston 32 fully lowered and in the orientation in which the cushion is compacted or folded within the cover 14. As the air bag housing is lowered onto the cover, the cushion is pressed into the interior or cover cavity. The mock inflator prevents the cushion from being placed in the center of the cover as also shown in FIG. 6. FIG. 6 additionally shows a mechanism fastener, such as nut 50, which secures each retainer stud to the flange of the mock inflator. The mock inflator 34 forms an impression or depression 42 in the air bag cushion 12 into which the actual inflator or inflator/horn assembly 36 will be placed. If the mock inflator (or piston) includes an electromagnet such as 45, after the magnetic field is removed, both the tube 16 and the piston 32 are raised and the module is then removed from the base. If the design of the folding apparatus does not include a mechanism to hold and release the air bag housing, which can be automatically disconnected from the housing, the sequence of raising the piston and tube will vary. For example, with a mechanical fastener, the tube 16 is first retracted, leaving the piston in its lowered position, the housing is disconnected from the mechanical fastener and the piston withdrawn. If a permanent magnet is used, the tube 16 can be retracted initially leaving the piston in place. Thereafter the operator can grasp the module, holding it in place as the piston is withdrawn, thereby disconnecting the magnetized mock inflator from the air bag housing.

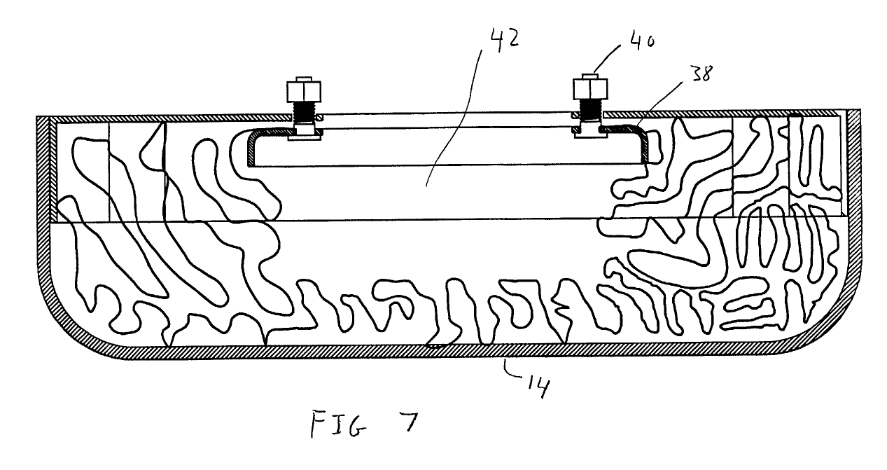

FIG. 7 shows the cover, housing and cushion in isolation; the mock inflator has been removed. The depression 42 formed by the mock inflator 34 can be clearly seen. A uniform thickness of cushion material will reside adjacent the undersurface of the cover 12, therefore a determinable amount of pressure will be needed to activate the horn switch (not shown in FIG. 7). Each air bag cushion 12 will be compacted into the interior 26 of its cover essentially the same way every time without intricate and time-consuming folding techniques. The cover 12 is then secured to the housing 28 in a known manner. For example, rivets can be used to fasten the housing and cover, if needed.

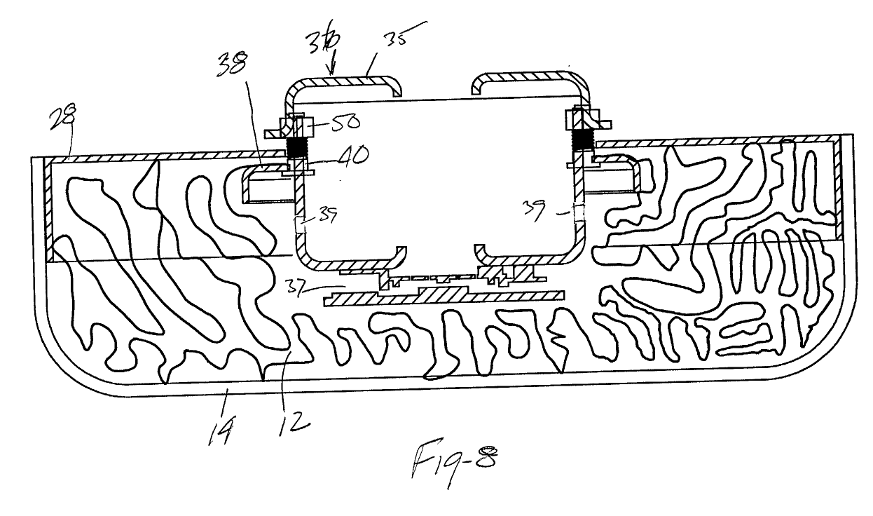

FIG. 8 shows a completed air bag module with the assembly 36 (with an inflator 35 and optional horn switch 37) installed into the depression 42 of the air bag cushion 12. The inflator assembly is secured to the housing with fasteners such as nuts 50 or rivets or other means.

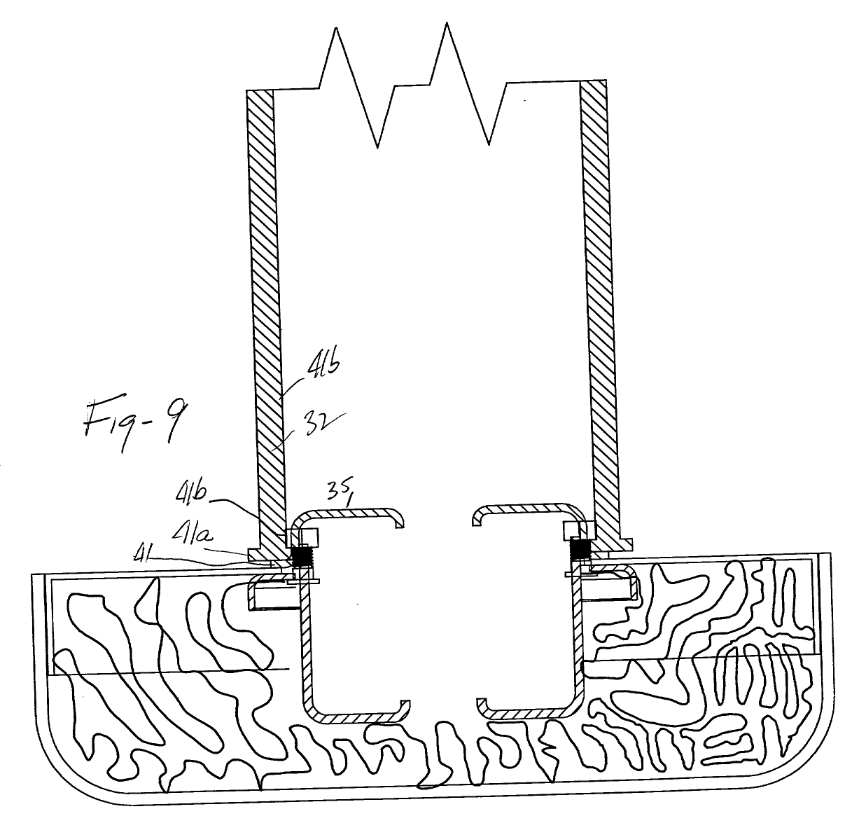

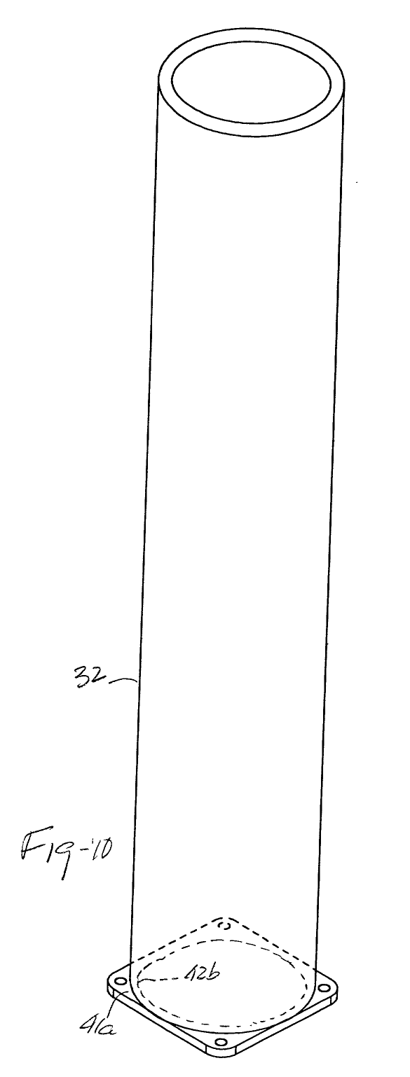

Reference is briefly made to FIGS. 9 and 10. In this embodiment the lower portion of the piston includes only the flange 41a with its openings. The mock inflator is not used. In this embodiment, the subassembly 31 also includes the actual inflator 35 and/or assembly 36. The inflator flange 41 is placed on the retainer studs and inserted within the housing opening 30 into the cushion. Thereafter this subassembly 31 is fitted to the piston flange and is movable therewith. The inflator is received within the opening 41b in the flange 41a (see FIG. 10). The extending rear of the inflator is positioned in the piston 32. As can be appreciated, the method of folding the cushion is the same as described above. As can be appreciated, the actual inflator is now automatically installed within the housing and in concert with the automatically folded cushion.

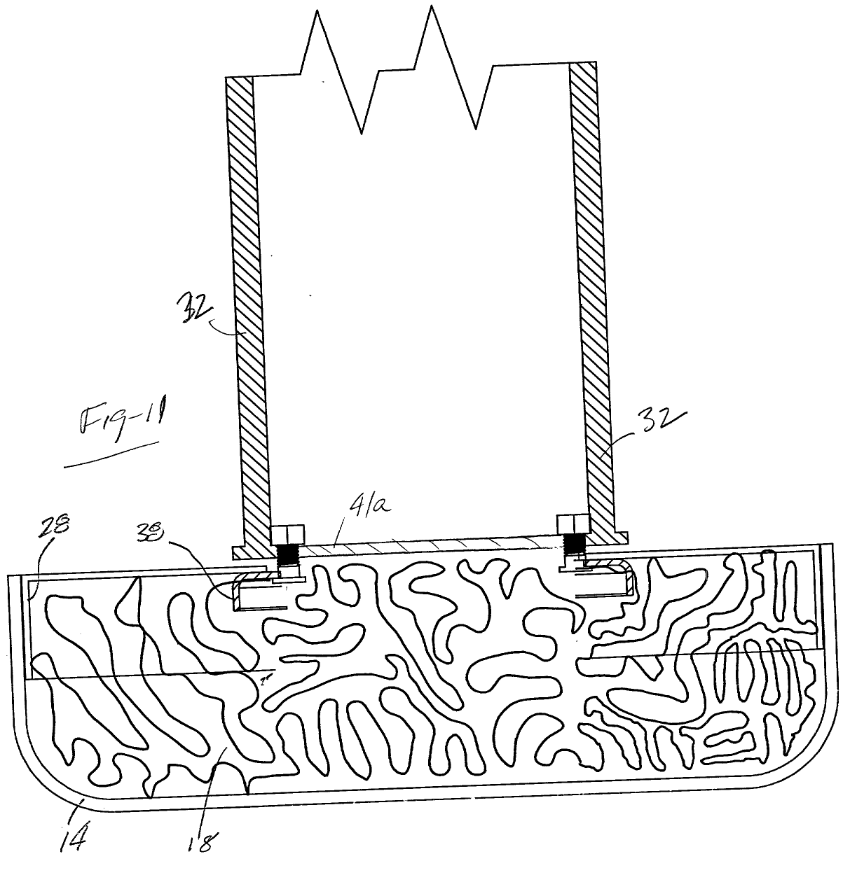

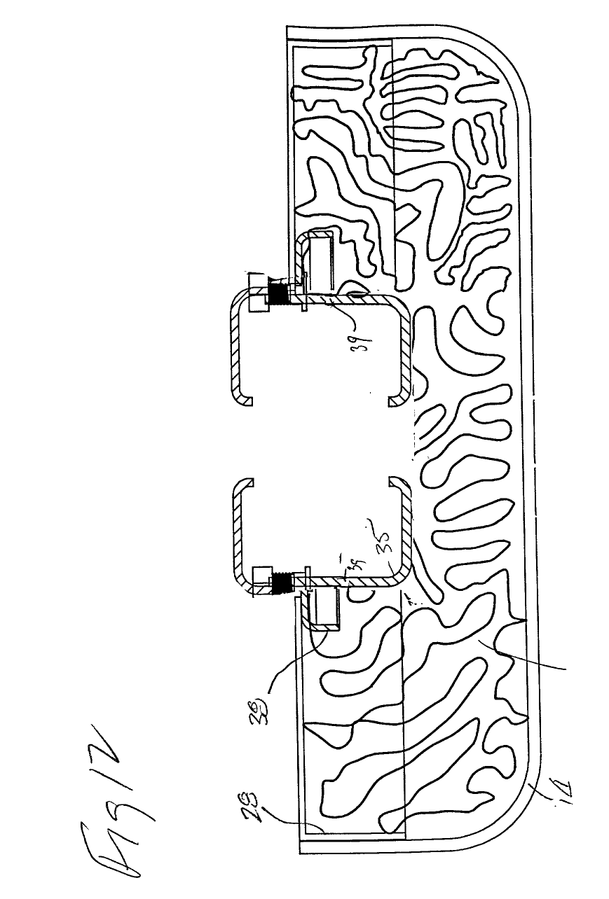

Reference is now made to FIG. 11, which shows a further embodiment of the invention, which uses neither the mock inflator nor the actual inflator in the process of inserting the cushion and folding the cushion in the cover. In this embodiment, the piston 32 is further modified in that the flange 41a, shown in FIG. 10, completely encloses the end of the piston; that is, opening 42d is removed or closed. In this embodiment, the retainer and cushion and housing are secured to each other as mentioned above and this subassembly is then secured to the flange 41a of piston 32. This subassembly may be secured to the piston by mechanical or electromechanical means. As before, the piston 32 is raised, thereby extending the air bag 18 within the interior walls of the tube. Thereafter, the piston is moved downwardly, placing the air bag 18 and the housing 28 within the cover. Subsequently, the housing is disconnected from the piston and the cover, air bag, housing, etc. are removed from the folding apparatus. As can be seen from the cross-sectional view in FIG. 11, by not using the mock inflator (or the actual inflator) a greater volume is provided into which the cushion (air bag) 18 can be folded.

Consequently, the folded configuration of the air bag shown in FIG. 11 is less dense than the air bag shown in the earlier drawings. The significance of this is that the air bag or cushion material in the vicinity of the central opening 30 of the housing is rather pliable or cushiony. Therefore, it is relatively easy to insert the forward portion of an inflator, that is that portion with exit ports 39 (such as shown in FIG. 8) through the opening 30 with very little resistance offered by the folded air bag. As before, this inflator would include a flange 41 to receive the studs 40 of the retaining ring 38 and will be secured by fasteners such as 50 in a manner as discussed above.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

1. A method for installing a cushion and an inflator/horn assembly to a cover having a cavity therein for the cushion, said method comprising the steps of:
attaching the cushion to a mock inflator;
securing the cover;
compacting the cushion into the cover and around said mock inflator, such that the cushion is received into a cover cavity defined by the cover; and
removing the mock inflator from said cushion, thereby forming a sleeve cavity within the cushion for an inflator/horn assembly.

2. The method of claim 1, wherein said compacting is further defined by the sleeve cavity being between the inflator/horn assembly and the cover such that a predetermined thickness of cushion is disposed between the sleeve cavity in the cushion and the cover such that a predetermined amount of force applied to the cover will activate the horn.

3. The method of claim 1, further including the step of inserting a retaining ring into a cushion such that said step of securing the cushion to the cover is further defined by attaching said retaining ring to the mock inflator.

4. The method of claim 1, further including a base to which the cover is secured, a housing having an upper and lower platform that defines a housing cavity, and a piston disposed within the housing cavity and slidable between the upper and lower platform, wherein said compacting step is further defined by guiding the cushion into the cavity of the cover through the tube cavity defined by the tube.

5. The method of claim 4, wherein the tube is movable between an open position and a closed position and the piston is movable relative to the tube, wherein said step of securing the cushion to the mock inflator is further defined by securing the mock inflator to the piston and further including the steps of raising the piston within the tube to the upper platform, lowering the lower platform of the tube onto the base securing the cover, and driving the piston within the housing cavity to compact the cushion into the cover cavity of the cover.

6. An assembly for assembling a cushion to a cover, said assembly comprising;
a base for supporting the cover;
a housing having an upper platform and a lower platform defining a housing cavity;
an air bag housing slidably disposed within said housing cavity;
a piston movable between said upper platform and said lower platform; and
a mock inflator attached to said piston.

7. An assembly as in claim 5, wherein said tube cavity is shaped to form the outer periphery of said cushion.

8. An assembly as in claim 5, wherein said mock inflator includes an outer periphery shaped to form an inner sleeve cavity within the cushion.

9. An assembly as in claim 5, wherein said cushion further includes a retaining ring to attach said cushion to said mock inflator.

10. An assembly as in claim 5, wherein said piston is pneumatically actuated between an open and closed position.

11. A method for installing a cushion into an interior cavity of a cover, said method comprising the steps of;
forming a cushion subassembly and attaching same to a movable piston, the subassembly including a cushion housing and the cushion;
positioning the cover apart from the piston;
moving the piston toward the cover to press the cushion into the cover, thereby folding same and positioning the housing atop the now folded cushion with the interior of the cover.

12. The method as defined in claim 11 wherein the step of assembling a subassembly includes securing an inflator to the air bag housing.
